(19) United States
(12) Patent Application Publication
(10) Pub. No.: US 2007/0024510 A1
(43) Pub. Date: Feb. 1, 2007

(54) SYSTEM AND METHOD FOR USE IN WIRELESS COMMUNICATION EMPLOYING MULTIPLE ANTENNAS

(75) Inventors: Riad Ghabra, Dearborn Heights, MI (US); John S. Nantz, Brighton, MI (US); Tom Q. Tang, Novi, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 11/425,521

(22) Filed: Jun. 21, 2006

Related U.S. Application Data
(63) Continuation-in-part of application No. 11/189,361, filed on Jul. 26, 2005.
(63) Continuation-in-part of application No. 11/189,373, filed on Jul. 26, 2005.

(51) Int. Cl. H01Q 1/32

(52) U.S. Cl. 343/711

(57) ABSTRACT

A system and method for use in wireless communication includes selectively connecting a communication circuit to one of multiple antennas. The system and method also include preventing the remaining antennas from interacting with the antenna connected to the communication circuit.

### CROSS-REFERENCE TO RELATED APPLICATIONS

The present application is a continuation-in-part of U.S. patent application Ser. No. 11/189,361, entitled “System And Method For Use In Wireless Communication Employing Antenna Network,” and a continuation-in-part of U.S. patent application Ser. No. 11/189,373, entitled “System And Method For Use In Wireless Communication Employing Multiple Antennas,” both of which were filed on Jul. 26, 2005 and are hereby incorporated by reference.

### TECHNICAL FIELD

The following relates to a system and method for use in wireless communication employing multiple antennas.

A detailed description and accompanying drawing are set forth below.

### BRIEF DESCRIPTION OF THE DRAWINGS

FIG. 1 is a block diagram depicting the system and method described herein.

### DETAILED DESCRIPTION

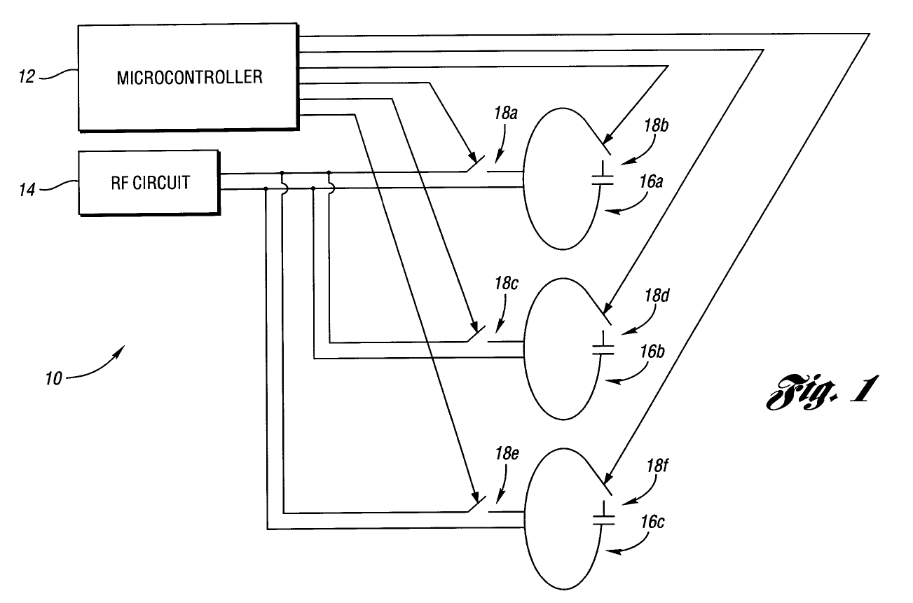

With reference to FIG. 1, a more detailed description of the system and method will now be provided. It is increasingly common in automotive vehicles to use wireless communication systems for a variety of applications. These include, but are not limited to, remote keyless entry (RKE), tire pressure monitoring (TPM), remote control of garage door opening (GDO) systems, vehicle immobilzation, voice activated controls, and others.

Many of these existing communication systems, whether they include a transmitters, receiver, or transceiver, are designed to operate in multiple frequency bands, or to perform pattern optimization within a fixed frequency band. As a result, such communication systems require either multiple antennas with multiple switches in a switching network, or a single antenna with variable components, such as a veractor diode, in order to tune that antenna to various frequencies. This leads to the further requirement of microprocessor control of the switching network or variable components, and may include the need for intelligent software.

Thus, there exists a need for a system and method for use in a communication system, such as for automotive applications including RKE, TPM, remote control of GDO systems, vehicle immobilization, voice activated controls, and the like, that allows for using multiple antennas without the need for tuning. That is, such a system and method would employ multiple antennas optimized for designated frequency bands, pattern optimization and/or polarization without the need for tuning circuitry or components.

Referring now more specifically to FIG. 1, a block diagram of the system and method described herein is shown, denoted generally by reference numeral 10. In general terms, the system and method provide an antenna concept for use in multi-frequency applications, particularly automotive applications such as RKE, TPM, remote control of GDO systems, vehicle immobilization, voice activated controls, or the like. The system and method allow for the use of a single transmitter, receiver or transceiver circuit for multiple frequency operating requirements (although more than one transmitter, receiver or transceiver circuits could also be used). The system and method employ multiple antennas for optimizing performance in different frequency bands.

As seen in FIG. 1, a controller (12) is provided for selectively connecting a communication circuit (14) to at least one of a plurality of antennas (16a, 16b, 16c). For simplicity, FIG. 1 shows three antennas (16a, 16b, 16c), although there is no limit to the number of antennas that could be used. It should also be noted that antennas (16a, 16b, 16c) may be of any type or combination of types including, but not limited to, loop, monopole, inverted F, or others.

Depending upon the desired application, communication circuit (14) may be a transmitter, receiver, or transceiver, and may include appropriate matching circuitry. One or more switches (18a, 18b, 18c, 18d, 18e, 18f) may be used for selectively connecting communication circuit (14) to an appropriate antenna(s) (16a, 16b, 16c) corresponding to the desired frequency band(s) of operation, depending upon the application. Switches (18a, 18b, 18c, 18d, 18e, 18f) may be any appropriate devices known to those of ordinary skill in the art, such as solid-state switches, and operate according to instructions from controller (12). Controller (12) may be an ASIC, a microcontroller, or other hardware switching control.

As an example only, the system and method (10) may be provided as part of an in-vehicle remote control for a garage door, security gate, or the like. In that regard, communication circuit (14) may be a transmitter or transceiver for generating activation signals to be transmitted by antennas (16a, 16b, 16c) to a receiver in a GDO system (not shown).

More specifically, most GDO systems are being designed to operate using activation signals having one of six carrier frequencies: 288, 300, 310, 315, 318 or 390 MHz. Other carrier frequencies, however, may be used. Depending upon the particular carrier frequency utilized by a GDO system, one of the three antennas (16a, 16b, 16c) will be optimal for use in transmitting an activation signal. That is, a first antenna (16a) may be provided for use in transmitting an activation signal having a carrier frequency of either 288 or 300 MHz. A second antenna (16b) may be provided for use in transmitting an activation signal having a carrier frequency of 310, 315 or 318 MHz. A third antenna (16c) may be provided for use in transmitting an activation signal having a carrier frequency of 390 MHz.

In that regard, the appropriate switch or switches (18a, 18b, 18c, 18d, 18e, 18f) are controlled to selectively connect the transmitter or transceiver (14) to the appropriate antenna (16a, 16b, 16c) depending upon the required or desired carrier frequency. As previously described, switches (18a, 18b, 18c, 18d, 18e, 18f) operate according to commands or instructions from controller (12).

Thus, each of the antennas (16a, 16b, 16c) can be optimized for operation in one of a plurality of designated frequency bands, any one or more (or all) of which may be as narrow as a single or specific frequency (e.g., 390 MHz). That is, antennas (16a, 16b, 16c) need not be tunable and no tuning circuitry or components for such antennas (16a, 16b, 16c) are required.

The plurality of frequency bands designated is based on those frequency bands or frequencies that may be utilized in various applications, such as RKE, TPM, remote control of GDO systems, vehicle immobilization, voice activated controls, and others. As can also be seen, controller (12) selectively connects the communication circuit (14) to at least one of the plurality of antennas (16a, 16b, 16c) based on the frequency band or bands required or desired.

More specifically, as an example only, controller (12) may control switch (18a) to selectively connect the communication circuit (14) to one of the plurality of antennas (16a) based on a desired or required one or more of the plurality of designated frequency bands. In that same regard, controller (12) may also control switch (18b) to close the loop of antenna (16a). At the same time, controller (12) may control switches (18c, 18e) to disconnect or isolate the remaining ones of the plurality of antennas (16b, 16c) from the communication circuit (14). In that same regard, controller (12) may also control switches (18d, 18f) to open the loops of antennas (16b, 16c). In such a fashion, controller (12) prevents antennas (16b, 16c) from interacting with the desired antenna (16a) when antenna (16a) is used to transmit a wireless signal.

Alternatively, switches (18b, 18d, 18f) could be eliminated from the design. In that event, controller (12) may control switch (18a) to selectively connect the communication circuit (14) to one of the plurality of antennas (16a) based on a desired or required one or more of the plurality of designated frequency bands. At the same time, controller (12) may control switches (18c, 18e) to disconnect or isolate the remaining ones of the plurality of antennas (16b, 16c) from the communication circuit (14). In such a fashion, controller (12) again prevents antennas (16b, 16c) from interacting with the desired antenna (16a) when antenna (16a) is used to transmit a wireless signal. In that regard, as an example only, such a design and operation may be desired where antenna (16a, 16b, 16c) may be provided for use in transmitting an activation signal having a carrier frequency of 300 MHZ, 433 MHZ, and 800 MHZ, respectively.

Controller (12) may also be provided for determining the desired or required one or more of the plurality of designated frequency bands Once again, although communication circuit (14) may be a transmitter or transceiver as discussed above, it may also or alternatively be a receiver depending upon the application selected.

As can also be seen, the method (10) comprises selectively connecting communication circuit (14) to one of the plurality of antennas (16a, 16b, 16c). In that regard, as previously described, each antenna (16a, 16b, 16c) may be optimized for operation in one of a plurality of designated frequency bands. Communication circuit (14) may comprise a transmitter, receiver or transceiver, and any one or more (or all) of the designated frequency bands may be as narrow as a single frequency.

The selective connection of communication circuit (14) to one of the plurality of antennas (16a, 16b, 16c) may be based on a desired one or more of the plurality of designated frequency bands, and the method (10) may still further comprise determining a desired one or more of the plurality of designated frequency bands. As noted above, the plurality of frequency bands designated is based on those frequency bands or frequencies that may be utilized in various applications, such as RKE, TPM, remote control of GDO systems, vehicle immobilization, voice activated controls, and others.

The method (10) may also comprises preventing those remaining ones of the plurality of antennas (16b, 16c) not connected with the communication circuit (14) from interacting with the one of the plurality of antennas (16a) selectively connected to the communication circuit (14). As previously described, this may be accomplished by controlling one or more switches (18c, 18d, 18e, 18f) to isolate or disconnect the remaining antennas (16b, 16c) from the communication circuit (14) and/or to open the loops of the remaining antennas (16b, 16c). It should be noted that the method (10) as described herein is exemplary, and that the functions of the method (10) could be undertaken other than in the order described and/or simultaneously as may be desired, permitted and/or possible.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for use in wireless communication, the system comprising:
a communication circuit;
a plurality of antennas, each antenna optimized for operation in one of a plurality of designated frequency bands; and
a controller for selectively connecting the communication circuit to one of the plurality of antennas based on a desired one of the plurality of designated frequency bands, and for preventing the remaining ones of the plurality of antennas from interacting with the one of the plurality of antennas selectively connected to the communication circuit.

2. The system of claim 1 wherein the communication circuit comprises a transceiver.

3. The system of claim 1 wherein the communication circuit comprises a transmitter.

4. The system of claim 1 wherein the communication circuit comprises a receiver.

5. The system of claim 2 wherein the transceiver is for use in an automotive application.

6. The system of claim 3 wherein the transmitter is for use in an automotive application.

7. The system of claim 4 wherein the receiver is for use in an automotive application.

8. The system of claim 1 wherein the controller controls a first switch to selectively connect the communication circuit to one of the plurality of antennas, and wherein the controller controls at least a second switch to open the remaining ones of the plurality of antennas in order to prevent the remaining ones of the plurality of antennas from interacting with the one of the plurality of antennas selectively connected to the communication circuit.

9. The system of claim 1 wherein each of the plurality of antennas is optimized for operation in one of a plurality of designated frequency bands, and the controller is further for determining a desired one of the plurality of designated frequency bands for use in selectively connecting the communication circuit to the one of the plurality of antennas based on the desired one of the plurality of designated frequency bands.

10. The system of claim 9 wherein at least one of the plurality of designated frequency bands comprises a single frequency.

11. The system of claim 9 wherein each of the plurality of designated frequency bands comprises a single frequency.

12. A method for use in wireless communications, the method comprising:
selectively connecting a communication circuit to one of a plurality of antennas; and
preventing the remaining ones of the plurality of antennas from interacting with the one of the plurality of antennas selectively connected to the communication circuit.

13. The method of claim 12 wherein the communication circuit comprises a transmitter.

14. The method of claim 12 wherein the communication circuit comprises a receiver.

15. The method of claim 12 wherein the communication circuit comprises a transceiver.

16. The method of claim 12 further comprising:
controlling a first switch to selectively connect the communication circuit to one of the plurality of antennas; and
controlling at least a second switch to open the remaining ones of the plurality of antennas in order to prevent the remaining ones of the plurality of antennas from interacting with the one of the plurality of antennas selectively connected to the communication circuit.

17. The method of claim 12 wherein each of the plurality of antennas is optimized for operation in one of a plurality of designated frequency bands, the method further comprising determining a desired one of the plurality of designated frequency bands for use in selectively connecting the communication circuit to the one of the plurality of antennas based on the desired one of the plurality of designated frequency bands.

18. The method of claim 17 wherein at least one of the plurality of designated frequency bands comprises a single frequency.

19. The method of claim 17 wherein each of the plurality of designated frequency bands comprises a single frequency.

20. The method of claim 12 wherein the communication circuit is for use in an automotive application.
